(19) United States
(12) Patent Application Publication
(10) Pub. No.: US 2013/0076261 A1
(43) Pub. Date: Mar. 28, 2013

(54) PROGRAMMABLE LIGHT-BOX

(71) Applicants: Tsun-I Wang, Taoyuan County (TW); Ching-Chun Wu, Taoyuan County (TW); Chia-Liang Yang, Taoyuan County (TW)

(72) Inventors: Tsun-I Wang, Taoyuan County (TW); Ching-Chun Wu, Taoyuan County (TW); Chia-Liang Yang, Taoyuan County (TW)

(21) Appl. No.: 13/246,168

(22) Filed: Sep. 27, 2011

(51) Int. Cl. H05B 37/02

(52) U.S. Cl. 315/297

(57) ABSTRACT

A light-box for illuminating a printed image includes a light source having a plurality of light-emitting sections, a plurality of contrast information, and a programmable light source controller. The plurality of contrast information is determined according to the contents of the printed image, with each piece of contrast information corresponding to one contrast generated by the plurality of light-emitting sections. Thus, the programmable light source controller drives the plurality of light-emitting sections according to the plurality of contrast information in order to generate luminance variations within different durations.

### BACKGROUND OF THE INVENTION

1. Field of the Invention

The present invention relates to a light-box; in particular, it relates to a light-box enabling programmable dynamic effects.

2. Description of Related Art

Light-boxes are commonly used in commercial advertisement promotions or partially employed for perspective applications of living area landscaping thereby adding variations to interior decorations. However, since the printed image on such light-boxes is typically a fixed pattern or texture which can not be altered in any fashion, the visual effect thereof becomes flat, plain and insignificant thus unable to attract a watcher's attention. On the other hand, although the printed image is clearly visible during daytime, its advertisement effects become void at dark night, so some external light sources are usually installed for the light-box in order to project light on the rear or front side of the printed image thereby presenting vividly the pattern on the printed image during nighttime; however, the light source of the light-box is simply used to illuminate the pattern on the printed image but no other variations can be created, thus incapable of providing desirable advertisement effects. Such a type of advertisement light-box can be implemented in a form of, such as, a fixed advertisement panel, a rotatable advertisement panel, a car roof advertisement or a wall advertisement board and so forth.

Traditionally the fluorescent lamp is used as the light source of the light-box, externally covered with the required color sheet. But the fluorescent lamp indeed poses some problems: (1) uneven light distribution in the light-box, where the areas closer to the lamp tend to be brighter but other farther ranges may be insufficiently illuminated; (2) high power consumption with reduced lifespan in use, with greater possibility in failure; and (3) significant influence on the volume of the light-box due to thickness of the fluorescent lamp, occupying more space thereof. At present, it has been devised to apply Light Emitting Diodes (LEDs) as the light source for the light-box thereby meeting the requirements on slimness, power-saving and environment protection. However, the use of LEDs as the light source so far is merely directed to replace the fluorescent lamp; thus the light controls over the LEDs are simple which need only to constantly emit light or otherwise require certain basic integral brightness controls. Consequently, the function of LED is not fully exploited.

### SUMMARY OF THE INVENTION

As such, one objective of the present invention is to provide a light-box enabling programmable dynamic effects thereby eliminating the aforementioned drawbacks.

The present invention provides a method for controlling the light source in the light-box. The light-box according to the present invention provides illumination for a printed image, comprising a light source having a plurality of light-emitting sections and a programmable light source controller. The method according to the present invention comprises determining a plurality of contrast information based on the contents of the printed image, with each piece of the contrast information corresponding to one contrast generated by the plurality of light-emitting sections; and driving the plurality of light-emitting sections by means of the programmable light source controller according to the plurality of contrast information in order to generate luminance variations within different durations.

Additionally, the present invention provides a light-box which can be used to illuminate a printed image. The light-box according to the present invention comprises a light source, a plurality of contrast information and a programmable light source controller. The light source is installed behind the printed image and includes a plurality of light-emitting sections. The plurality of contrast information is determined according to the contents of the printed image, with each piece of contrast information corresponding to one contrast generated by the plurality of light-emitting sections. In addition, the programmable light source controller drives the plurality of light-emitting sections according to the plurality of contrast information in order to generate luminance variations within different durations.

### BRIEF DESCRIPTION OF THE DRAWINGS

FIG. 1 shows a diagram for a first embodiment of a light-box according to the present invention.

FIG. 2 shows a diagram for the control system in the light source of the light-box according to the present invention.

FIG. 3 shows a diagram illustrating the drive circuit in the programmable light source controller according to the present invention.

FIG. 4 shows a diagram for the control signal of the light source in a normal portion.

FIG. 5 shows a diagram for the control signal of the light source in a highlight portion.

FIG. 6 shows a time sequence diagram for the control signal of the light source in a normal portion.

FIG. 7 shows a diagram for a second embodiment of the advertisement light-box according to the present invention.

FIG. 8 shows a diagram for a third embodiment of the advertisement light-box according to the present invention.

FIG. 9 shows a diagram for a fourth embodiment of the advertisement light-box according to the present invention.

FIG. 10 shows a flowchart for the method of controlling the light source of the advertisement light-box according to the present invention.

### DETAILED DESCRIPTION OF THE PREFERRED EMBODIMENTS

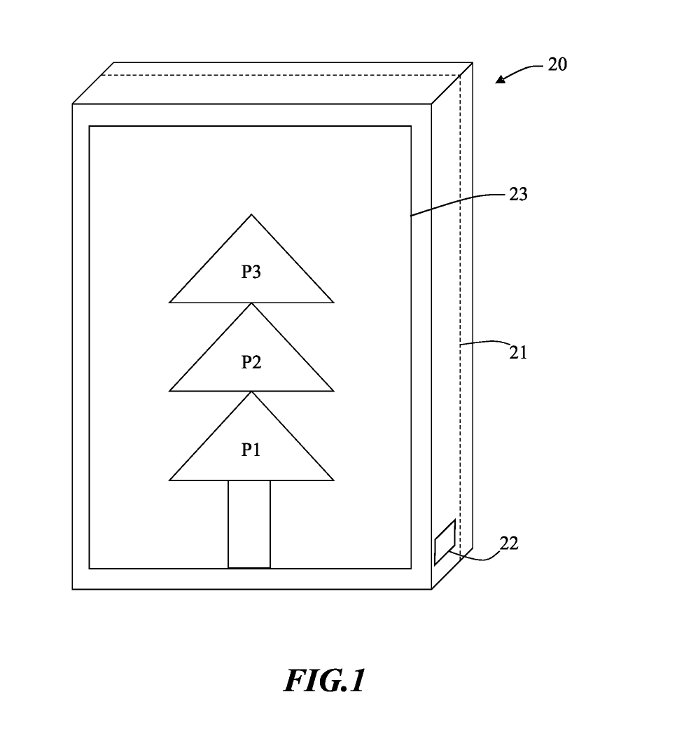

Refer initially to FIG. 1, wherein a diagram for a first embodiment of a light-box according to the present invention is shown. The illustrated light-box 20 comprises a light source 21 and a programmable light source controller 22. The light source 21 is installed behind the printed image 23 and the programmable light source controller 22 is used to drive the light source 21 so as to illuminate the printed image 23. A user can edit the contrast information thereby controlling the brightness in the light source 21, and then input the contrast information to the programmable light source controller 22. The light source 21 can be an array of Light Emitting Diodes (LEDs), with the illumination and brightness in each of the LEDs being individually controlled thus allowing the light-box according to the present invention to enable more features than those can be provided by the conventional light-box: (1) the power-on or power-off in any area of the light source can be controlled thereby offering the dynamic screen effect; (2) the illumination and brightness in any area can be adjusted so as to save electric power; and (3) the contrast can be enhanced in terms of the specific printed image to attract people's attention.

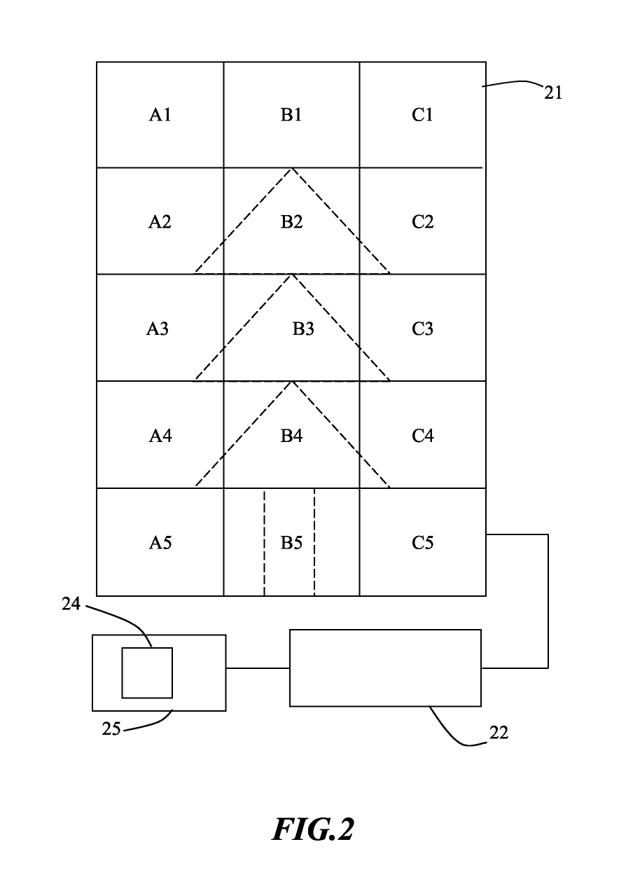

Refer next to FIG. 2, wherein a diagram for the control system in the light source of the light-box according to the present invention is shown. The light source 21 includes a plurality of light-emitting sections A1 to C5, with each piece of the contrast information 24 corresponding to the contrast generated by a light-emitting sections A1 to C5, so that the programmable light source controller 22 can drive the light source 21 based on the plurality of contrast information 24 in order to generate luminance variations within different durations. The plurality of contrast information 24 is stored in an external memory 25 which may be a portable memory or a memory card. The programmable light source controller 22 can read the plurality of contrast information 24 directly from the external memory 25; or alternatively, the plurality of contrast information 24 can be copied and saved to an internal memory of the programmable light source controller 22 and then the external memory 25 can be removed. Each of the light-emitting sections in the light source 21 contains at least one LED or a plurality of LEDs which can be a white LED or a composition of red, green and blue LEDs. Each of the light-emitting sections can be individually controlled; that is, the programmable light source controller 22 is allowed to respectively adjust the illuminance, hue as well as illumination duration of each light-emitting section. Besides, the brightness control on each of the light-emitting sections is divided into several levels from fully dark to fully bright, commonly consisting of 8 or 4 levels. In the present embodiment, the user needs only to set up the plurality of contrast information 24 for the light-emitting sections A1 to C5 in accordance with the contents of the printed image 23, with each piece of the contrast information 24 recording the highlight portions and normal portions in the printed image 23. As shown in FIG. 1, the printed image 23 essentially includes patterns P1, P2 and P3, so that the light-emitting sections B4, B3 and B2 corresponding to such patterns P1, P2 and P3 indicate the highlight portions, while the rest represent the normal portions. Suppose these light-emitting sections B4, B3 and B2 are sequentially illuminated, watchers can see a dynamic Christmas tree shining from bottom to top. The controls over these light-emitting sections can be done by means of three pieces of contrast information 24, in which a first contrast information 24 controls illumination of the light-emitting section B4 but other light-emitting sections remain dark; a second contrast information 24 controls illumination of the light-emitting section B3 but other light-emitting sections remain dark; and a third contrast information 24 controls illumination of the light-emitting section B2 but other light-emitting sections remain dark; in this way, when the programmable light source controller 22 drives the light source 21 sequentially based on such first, second and third contrast information 24, the light-emitting sections B4, B3 and B2 can light up one after the other. In addition, each time after replacement of the printed image 23, the user may re-enter the plurality of contrast information 24 through the external memory 25 in order to achieve the objective of programmability.

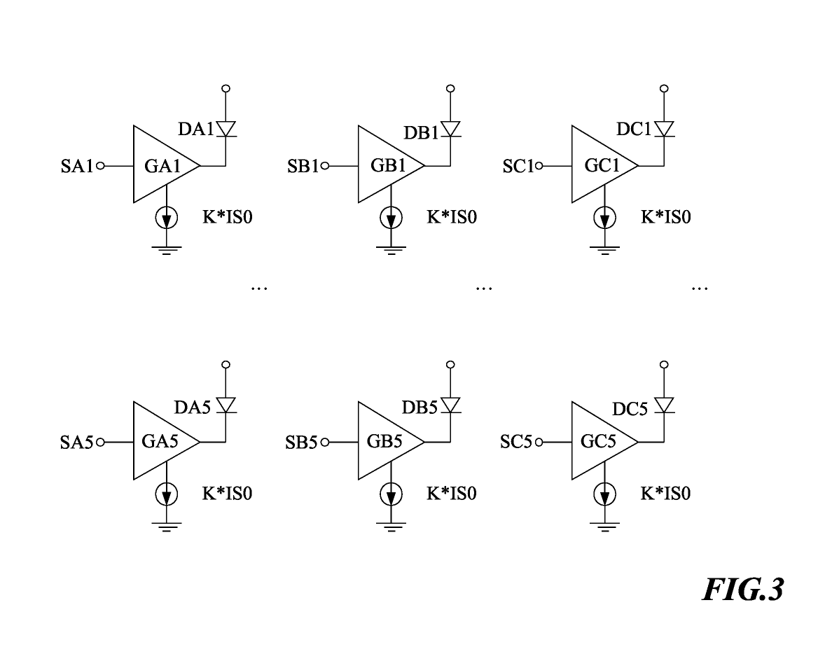

Refer then to FIG. 3, wherein a diagram illustrating the drive circuit in the programmable light source controller according to the present invention is shown. The LED in each light-emitting section of the light source 21 is driven by an independent LED driver based on an individual control signal; for example, the LEDs DA1 to DA5 in the light-emitting sections A1 to C5 are respectively driven by the LED drivers GA1 to GA5 in accordance with the control signals SA1 to SA5. The constant current in the LED driver is K times of the rating current IS0 of the LED; that is, the drive current is equal to K*IS0, and the LED driver controls illumination of the LED by using a pulse width modulation (PWM) control signal of duty ratio 1/K, so the average current of the drive current is equal to the rating current of the LED. Generally speaking, the normal portion in the printed image 23 may still retain a certain degree of illuminance, thus the brightness in the highlight portion must be greater than the one in the normal portion; in other word, the LED in the highlight portion needs to generate higher illuminance so as to create sufficient contrast. The illuminance of a common light-box may range from about 1500 to 2000 lux; consequently, in order to acquire a 4-time contrast the illuminance in the highlight portion needs reach up to 6000 to 8000 lux. The LED features a fast response speed and the illuminance of LED is approximately proportional to the drive current thereof; for example, the normal drive current for the LED is about 20 mA, so if the drive current is elevated to 80 mA in a short duration of time, the illuminance of the LED will become 4 times of the original one. However, in case the time to drive the LED with greater current lasts too long, the thermal effect caused by such a greater current may lead to temperature increase such that the brightness generated by the LED undesirably decreases. Furthermore, the required cost for making all of the LEDs in such light-emitting sections capable of generating 6000 to 8000 lux may be unacceptably high. As a result, the light-box 20 according to the present invention uses the PWM control signal to adjust the illuminance in the highlight portions to be several times of the ones in the normal portions, while each light-emitting section needs only to generate an illuminance of 1500 to 2000 lux, thereby saving the cost for integral materials.

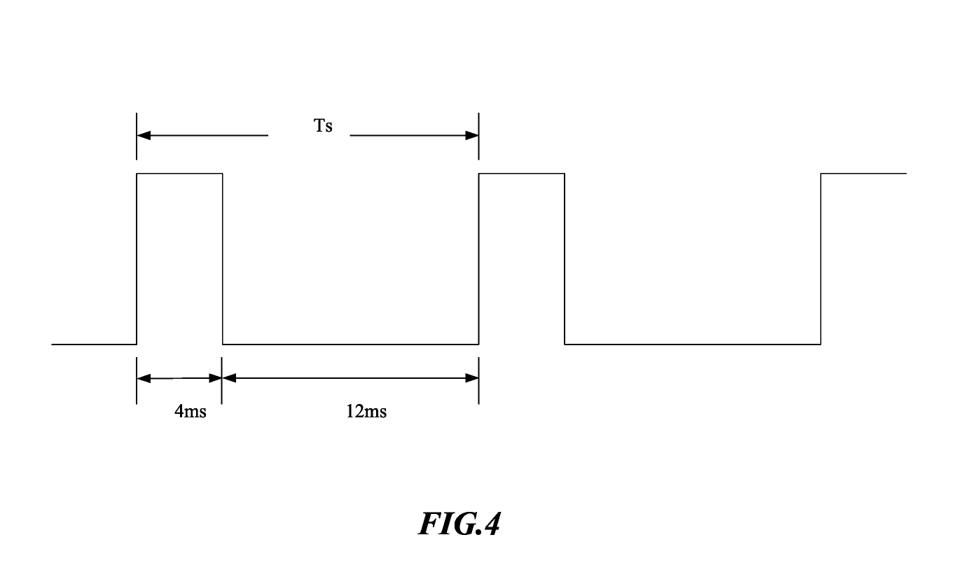

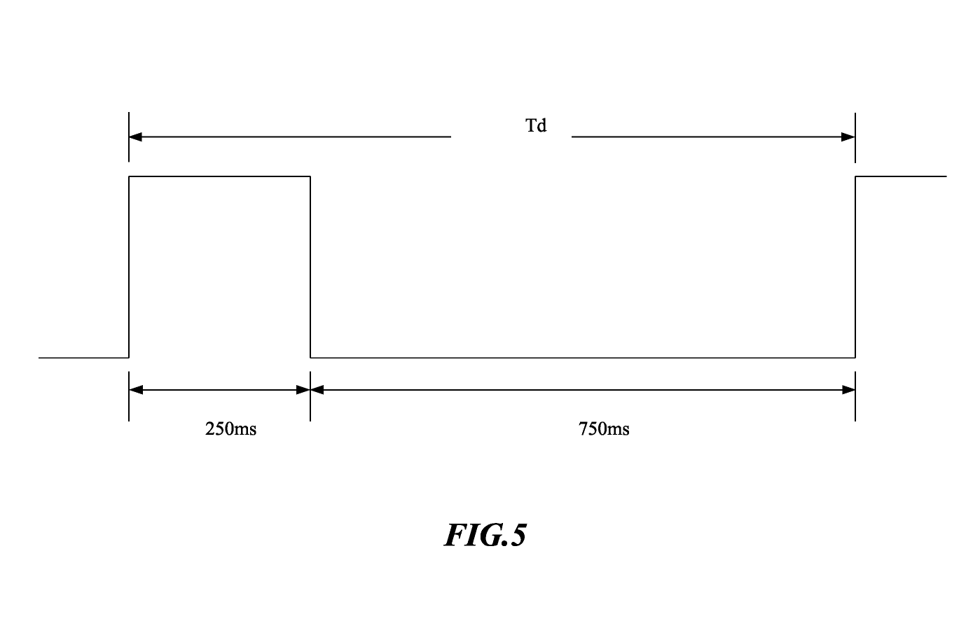

Refer now to FIGS. 4 and 5, wherein FIG. 4 shows a diagram for the control signal of the light source in a normal portion and FIG. 5 shows a diagram for the control signal of the light source in a highlight portion. In the present embodiment, the duty ratio of PWM control signals for the LEDs is set to be 1/K, but there actually exist two types of period for the PWM control signal, where the first period Ts operates on the control over the LED in a normal portion and can be set to be less than 16 ms, while the second period Td operates on the control over the LED in a highlight portion and can be set as ¼ second, 2/4 second, ¾ second or 1 second, depending on the requirement on the LED in the highlight portion. Due to the visual persistence effect in human eyes, when the blink frequency of LED illumination becomes greater than 30 times per second, human eyes cannot perceive LED blinks but continuous LED illumination, and the brightness perceived by human eyes is the average of the LED blinks Therefore, by driving the LED with the same drive current, it is possible to control the brightness in the LED through adjusting the period of the control signal. As shown in FIG. 4, the period Ts of the PWM control signal is 16 ms and the duty ratio is 25%, then the conductance time for the LED is 4 ms and the cut-off time is 12 ms, hence the blink frequency of the LED becomes 62 times per second and accordingly human eyes can perceive a continuous illumination with an illuminance level reaching approximately 25% of the highest illuminance On the other hand, as shown in FIG. 5, by driving the LED with the same drive current, the period Td of the PWM control signal is now 1000 ms and the duty ratio is 25%, then the conductance time for the LED is 250 ms and the cut-off time is 750 ms, hence the blink frequency of the LED becomes 1 time per second and accordingly the visual persistence effect is eliminated so that human eyes can actually see blinks with an alternative bright/dark twinkling illumination with an illuminance level equal to the highest illuminance As such, under the circumstance of driving with the same drive current to such LEDs, by adjusting the period of the control signal, it is possible to make the illuminance of the highlight portion in the light-box become 4 times of the ones in the normal portion.

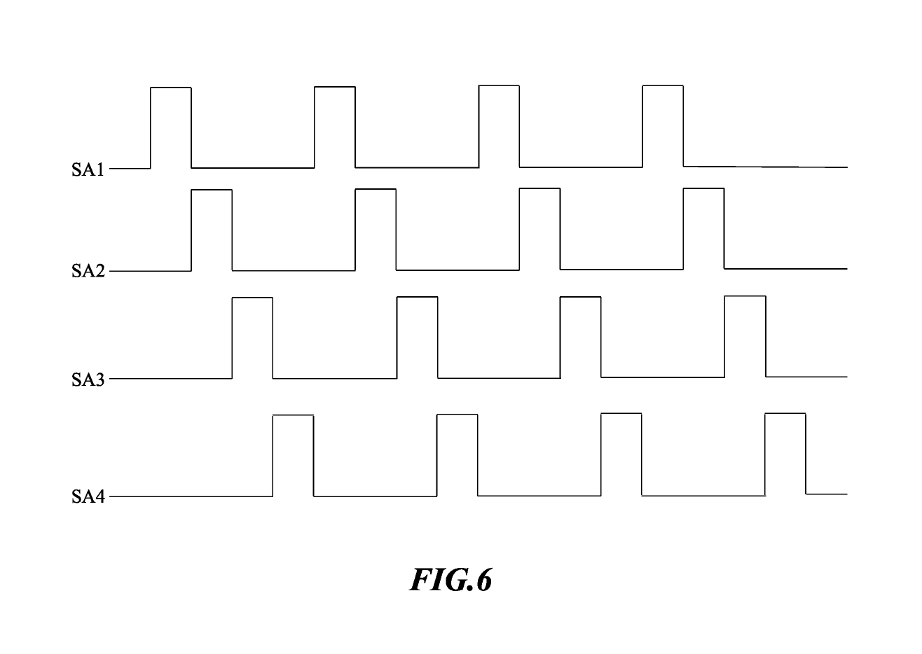

Refer to FIG. 6, wherein a time sequence diagram for the control signal in the light source of a normal portion is shown. The regulations for a general power supply specify the rating power as well as the transient maximum power which is usually approximately 135˜150% of the rating power. Assuming that the current in each LED driver as FIG. 3 is 80 mA with the LED voltage 4V and the total amount of the LEDs 1000, when the control signals of power-on to all LED drivers are located at the same position in time, thus regarding to the power supply, the maximum power is the sum of the powers for all of the drivers, then the rating power of the power supply must be set to be 80 mA×4V×1000=320 W, whereas the average power consumed by the LEDs is actually ¼ of it, i.e. approximately 80 W. So, in the present embodiment, it is possible to implement a time sequence arrangement for the control signal of LED driver activation such that the light-emitting sections corresponding to the normal portions may not be all activated at the same point of time, thus facilitating application of a power supply providing lower rating power. As shown in FIG. 6, taking the normal portions of the light source 21 as an example, the clocks of conductance time for the light-emitting sections in the first row, A1, B1, C1 to the light-emitting sections in the fourth row, A4, C4 do not overlap, which indicates the time sequence is arranged based on the conductance time of every four rows of light-emitting sections, thus the clock of conductance time for the light-emitting sections in the fifth row is identical to the one for the light-emitting sections in the first row where only ¼ of the LEDs in the light source 21 illuminate at the same time, and accordingly the rating power of the power supply is required to be configured as ¼ of the value set forth above, i.e., approximately 80 W. Meanwhile, since the total amount of LEDs in the highlight portions may not be great, the influence caused thereby on the rating power of the power supply is insignificant and the time sequence arrangement for the clocks of conductance time to the LEDs in the highlight portion is optional.

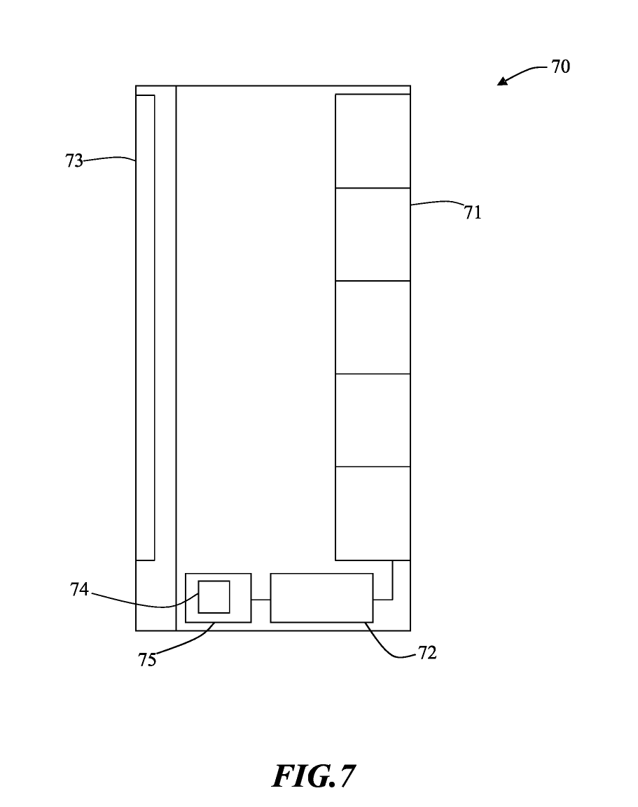

Refer now to FIG. 7, wherein a diagram for a second embodiment of the light-box according to the present invention is shown. The depicted light-box 70 comprises a light source 71, a programmable light source controller 72 as well as a wireless module 75. After completion of contrast information edition by a user, it is possible to apply wired or wireless transmissions to transmit the contrast information to the programmable light source controller. The wired transmission can be employed to connect the programmable light source controller with a host computer through a network line or a transmission line. The wireless transmission can be utilized to transmit the contrast information to the programmable light source controller by means of infrared, Bluetooth or wireless network. In the present embodiment, the user is allowed to transmit the contrast information 74 to the wireless module 75 via the wireless network, and the wireless module 75 is electrically connected to the programmable light source controller 72 for receiving the contrast information 74 and inputting the contrast information 74 to the programmable light source controller 72. In this way, the programmable light source controller 72 drives the light source 71 according to the received contrast information 74 to generate luminance variations within different durations.

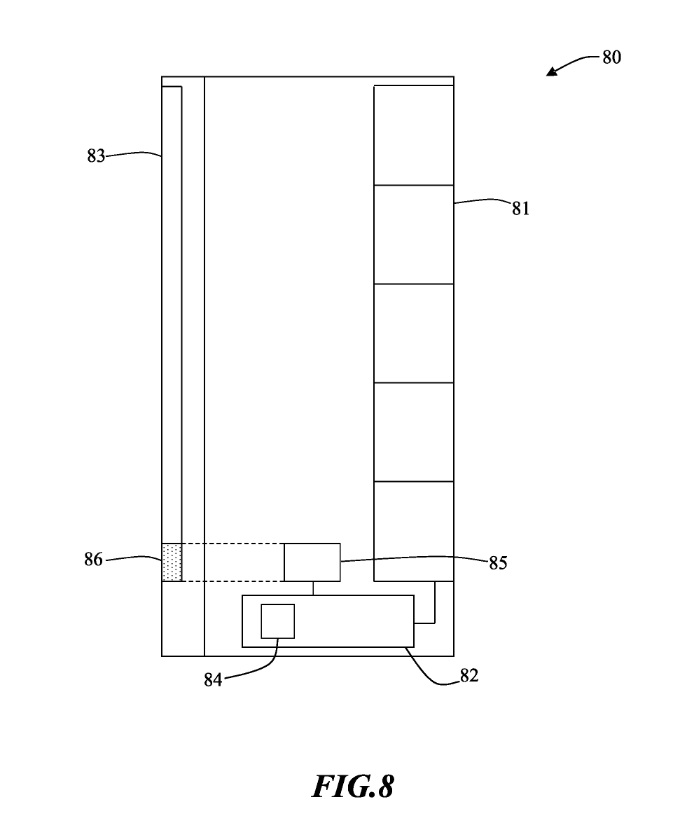

Refer to FIG. 8, wherein a diagram for a third embodiment of the light-box according to the present invention is shown. The light-box 80 comprises a light source 81, a programmable light source controller 82 and an information reader 85. In the present embodiment, a user determines a plurality of contrast information 84 based on the contents of the printed image 83 and records the plurality of contrast information 84 on the printed image 83 by using the identification tag 86, wherein the identification tag 86 may be a barcode, a radio frequency identification (RFID) tag, or a near field communication (NFC) tag. Furthermore, the barcode can be implemented by a 2-dimensional barcode (e.g. QR code) to register more information. The information reader 85 is electrically connected to the programmable light source controller 82 in order to read the identification tag 86 to acquire the contrast information 84 and input the acquired contrast information into the programmable light source controller 82. In this way, each time after replacement of the printed image 83, the programmable light source controller 82 can obtain the contrast information 84 by means of the information reader 85 in accordance with the identification tag 86 recorded on the printed image 83, and then drive the light source 81 based on the contrast information 84 to generate luminance variations within different durations.

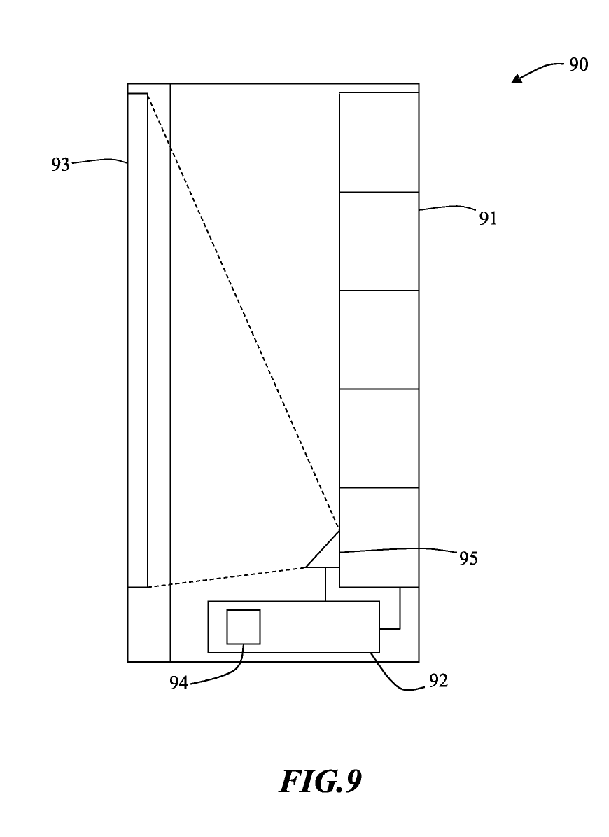

Refer to FIG. 9, wherein a diagram for a fourth embodiment of the light-box according to the present invention is shown. The light-box 90 as shown comprises a light source 91, a programmable light source controller 92 as well as a sensor 95. The sensor 95 detects the light transmittance of the printed image 93 and generates a plurality of contrast information 94 based on the detected light transmittance of the printed image 93. In the present embodiment, the user needs not to edit the contrast information 94, but rather, each time after replacement of the printed image 93, the programmable light source controller 92 generates a plurality of contrast information 84 according to the light transmittance of the printed image 93 detected by the sensor 95 and drives the light source 91 based on the contrast information 94 to generate luminance variations within different durations.

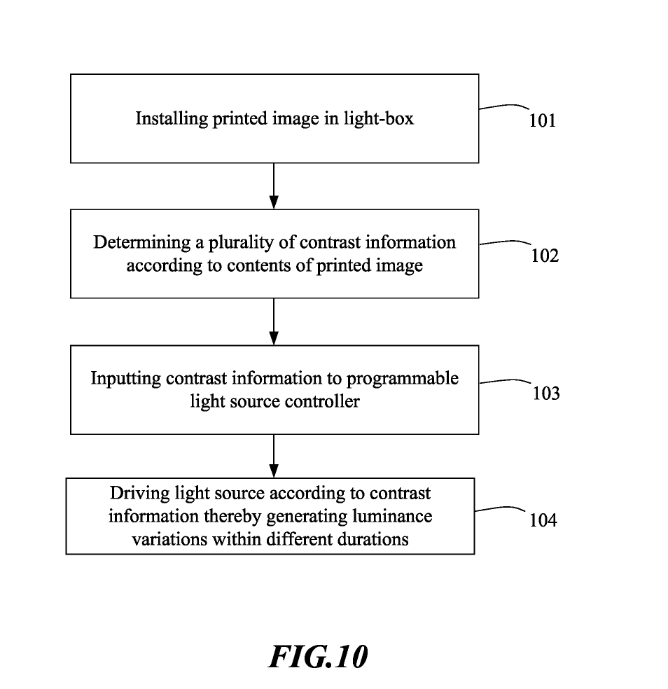

Refer next to FIG. 10, wherein a flowchart for the method of controlling the light source of the light-box according to the present invention is shown. The light-box comprises a light source, a plurality of contrast information and a programmable light source controller, and the method of controlling the light source of the light-box according to the present invention comprises the following steps:
STEP 101: installing a printed image in the light-box.
STEP 102: determining a plurality of contrast information according to the contents of the printed image. The user can edit the plurality of contrast information with a host computer, or alternatively use an identification tag to record the contrast information on the printed image. In addition, the programmable light source controller may generate the contrast information by way of detection on the light transmittance of the printed image with a sensor.
STEP 103: inputting the contrast information to the programmable light source controller. The user is allowed to store the contrast information in an external memory and then have it electrically connected to the programmable light source controller, or otherwise transmit the contrast information to the programmable light source controller by way of wired or wireless transmission. In addition, the programmable light source controller can acquire the contrast information by means of an information reader in accordance with the identification tag recorded on the printed image.
STEP 104: The programmable light source controller drives the light source according to the contrast information to generate luminance variations within different durations. For example, the programmable light source controller may drive such light sources with the same drive current but apply the control signal of different periods thereby generating a blinking backlight of high illuminance in the highlight portion and a continuous backlight of low illuminance in the normal portion.

In summary of the aforementioned descriptions, the present invention provides a light-box enabling programmable dynamic effect wherein it is possible to utilize the feature of individual controllability on the illumination of LED so as to achieve the objectives of dynamic backlight facilitating advertisement contents highlights as well as power-saving. The light-box according to the present invention can be used to illuminate a printed image, comprising a light source having a plurality of light-emitting sections, a plurality of contrast information, and a programmable light source controller. The plurality of contrast information is determined according to the contents of the printed image, with each piece of contrast information corresponding to one contrast generated by the plurality of light-emitting sections. Thus, the programmable light source controller drives the plurality of light-emitting sections according to the plurality of contrast information in order to generate luminance variations within different durations.

Those skilled in the art will readily observe that numerous modifications and alterations of the device and method may be made while retaining the teachings of the invention.

What is claimed is:

1. A method for controlling the light source of a light-box wherein the light-box provides illumination for a printed image and includes a light source having a plurality of light-emitting sections and a programmable light source controller, which method comprising:
determining a plurality of contrast information according to the contents of the printed image, with each piece of contrast information corresponding to one contrast generated by the plurality of light-emitting sections; and
driving the plurality of light-emitting sections according to the plurality of contrast information by the programmable light source controller in order to generate luminance variations within different durations.

2. The method according to claim 1, further comprising:
storing the plurality of contrast information in an external memory; and
electrically connecting the external memory to the programmable light source controller.

3. The method according to claim 1, further comprising:
transmitting the plurality of contrast information to the programmable light source controller through wired or wireless transmissions.

4. The method according to claim 1, further comprising:
recording the plurality of contrast information on the printed image by means of an identification tag; and
reading the identification tag by using an information reader so as to provide the programmable light source controller with the plurality of contrast information.

5. The method according to claim 1, wherein determining the plurality of contrast information according to the contents of the printed image comprises:
detecting the light transmittance of the printed image by using a sensor; and
generating the plurality of contrast information according to the light transmittance of the printed image.

6. The method according to claim 1, further comprising:
driving the plurality of light-emitting sections with the pulse width modulation (PWM) control signal of different periods by the programmable light source controller such that the plurality of light-emitting sections generate illumination contrasts.

7. The method according to claim 1, further comprising:
driving only a part of the light-emitting sections in the light source to illuminate at the same time by the programmable light source controller.

8. A light-box for providing illumination for a printed image, comprising:
a light source, installed behind the printed image and including a plurality of light-emitting sections;
a plurality of contrast information, determined according to the contents of the printed image, with each piece of contrast information corresponding to one contrast generated by the plurality of light-emitting sections; and
a programmable light source controller, driving the plurality of light-emitting sections according to the plurality of contrast information in order to generate luminance variations within different durations.

9. The light-box according to claim 8, further comprising:
an external memory, electrically connected to the programmable light source controller for storing the plurality of contrast information.

10. The light-box according to claim 8, further comprising:
a wireless module, electrically connected to the programmable light source controller for receiving the plurality of contrast information.

11. The light-box according to claim 8, further comprising:
an identification tag, disposed on the printed image for recording the plurality of contrast information; and
an information reader, electrically connected to the programmable light source controller for reading the identification tag so as to provide the programmable light source controller with the plurality of contrast information.

12. The light-box according to claim 8, further comprising:
a sensor, electrically connected to the programmable light source controller for detecting the light transmittance of the printed image so as to generate the plurality of contrast information.

13. The light-box according to claim 8, wherein the programmable light source controller uses the pulse width modulation (PWM) control signal of different periods to drive the plurality of light-emitting sections such that the plurality of light-emitting sections generate illumination contrasts.

14. The light-box according to claim 8, wherein the programmable light source controller drives only a part of the light-emitting sections in the light source to illuminate at the same time.

15. The light-box according to claim 8, wherein the light source is an array of Light-Emitting Diodes (LEDs) and the programmable light source controller can drive independently each of light-emitting sections in the array of LEDs.

16. The light-box according to claim 11, wherein the identification tag is a barcode, a radio frequency identification (RFID) tag, or a near field communication (NFC) tag.
